(19) United States
(12) Patent Application Publication
(10) Pub. No.: US 2009/0325562 A1
(43) Pub. Date: Dec. 31, 2009

(54) HYPERVISOR FOR MANAGING A DEVICE HAVING DISTINCT VIRTUAL PORTIONS

(75) Inventors: Paul J. Hough, North Bend, WA (US); Mary P. Czerwinski, Woodinville, WA (US); Anoop Gupta, Woodinville, WA (US); Raymond E. Ozzie, Seattle, WA (US); Pavel Curtis, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/145,563

(22) Filed: Jun. 25, 2008

(51) Int. Cl. H04M 3/00

(52) U.S. Cl. 455/418

(57) ABSTRACT

A single device can be compartmentalized into two or more virtual portions, wherein each virtual portion is associated with a user role. Each virtual portion can retain information, communications, resources, and/or functions separate from the other virtual portions. As a user changes roles, a different virtual portion can be accessed (automatically and/or manually) in order to maintain separation or confidentiality among the portions and associated roles. In such a manner, a user can utilize a single device for multiple roles.

### BACKGROUND

Wireless mobile technology has become widespread and is utilized for both personal as well as business uses. Mobile devices such as telephones, pagers, personal digital assistants (PDAs), data terminals, and the like, are designed to be carried by those who travel from place to place in the daily course of business, for personal reasons, or for both business and personal reasons.

The appeal of mobile devices is due in large part to the convenience of having such devices available regardless of where the user may be located (e.g., at home, at work, traveling, out of town, and so on). In such a manner, users can easily stay “connected”. These computing devices can be accessed at almost any time and place and can contain a tremendous amount of information relating to people, organizations, general interests, and other items. Electronic storage mechanisms have enabled accumulation of massive amounts of data. For instance, data that previously required volumes of books for recordation can now be stored electronically without the expense of printing paper and with a fraction of the physical space needed for storage of paper.

Some individuals manage different devices for different functions, roles, or personas. A first device might be utilized for work applications (e.g., a work persona) and a second, separate device might be utilized for personal applications (e.g., a personal persona). For example, a worker might have a mobile business phone and a mobile personal phone. If the worker is conducting an activity relating to their employer, the mobile business phone is utilized. If, however, personal communications are being made, the mobile personal phone is utilized.

The use of different devices for different functions does not create issues with regard to confidentiality. However, utilizing separate devices is cumbersome and can become costly. Thus, sometimes a single device is utilized for both personal and business uses. If the individual uses the personal device for work functions, it can be difficult for the employer (and device user) to monitor and control confidential or sensitive work-related communications through the personal device. Thus, confidential relationships might be inadvertently breached or other situations might develop, such as personal information being known by the employer and co-workers.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with providing a hypervisor that can control various portions of a single device while not controlling or influencing other portions of the device. The hypervisor can maintain two or more separate virtual devices or virtual portions in a single device. In such a manner, the single device can function as if it is two or more separate devices. Thus, an individual can use one device for all data, regardless of whether the data is intended for business, personal, or other functions. In addition, one virtual portion can be modified without affecting the other virtual portions. For example, a work-related portion and all applications, functions, etc. related to the work-related portion can be selectively removed, added, modified and so forth without having any impact on a personal (or other) virtual portion.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system for administrating virtual portions on a single device.

FIG. 2 illustrates a system for managing a device having distinct virtual portions.

FIG. 3 illustrates a system for maintaining two or more separate virtual devices within a single device.

FIG. 4 illustrates a system for supporting multiple roles on a device in a secure manner.

FIG. 5 illustrates a system that employs machine learning and reasoning, which facilitates automating one or more features in accordance with the one or more aspects.

FIG. 6 illustrates a method for managing a device having distinct virtual portions.

FIG. 7 illustrates a method for selectively partitioning a device based on a user role and routing inputs to a designated portion.

FIG. 8 illustrates a block diagram of a computer operable to execute the disclosed aspects.

FIG. 9 illustrates a schematic block diagram of an exemplary computing environment operable to execute the disclosed aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

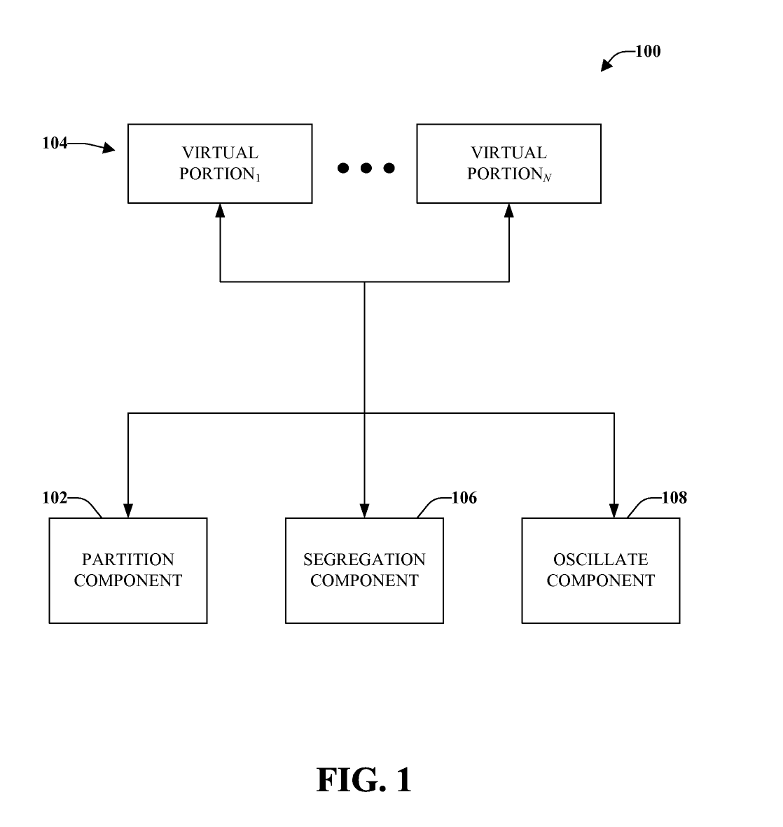

Referring initially to FIG. 1, illustrated is a system 100 for administrating virtual portions on a single device. System 100 is similar to a hypervisor or virtual machine monitor that provides a virtualization platform that allows multiple operating systems to run on a host device at substantially the same time. An individual might have various means or classifications through which they can be contacted. Such classifications can include a business phone number, a personal phone number, a home phone number, a personal email alias, a work email alias, and so forth. For many communications, separate devices are required (e.g., more than one cell phone, personal computer) for the different classifications and/or different contact numbers In addition, if the individual uses the personal device for work functions, it can difficult for the employer to monitor and control confidential or sensitive work-related communications through the personal device.

In further detail, system 100 includes a partition component 102 that can be configured to divide a single device (e.g., operating system) into two or more virtual portions (e.g., operating systems), each virtual portions corresponding to a different user role. The single device can be any computing device, both wired and wireless. As illustrated, the two or more virtual portions are labeled virtual portion₁ through virtual portion_{N}, where N is an integer, and referred to collectively as virtual portions 104. The virtual portions 104 can be configured to perform independent functionality as if each portion is a separate device.

Each virtual portion 104 can correspond to a different user role, which can be a work role, a personal role, a student role, and other roles. At any time, a user could be performing functions associated with a particular role. There are at least two types of roles: (1) a person as associated with their job (e.g., title, position, responsibility) and (2) a person as a private individual (e.g., personal, family) as well as other roles (e.g., a person as a member of a club, organization, friend, student, public figure, volunteer, community member, and so forth). Roles can be utilized for managing communications but can also be utilized as a filter for all resources on the communication device. For example, a role can be utilized to filter games, photographs, files, calling history, and others that are visible and accessible through the communication device.

Partition component 102 can configure the virtual portions 104 based on a manual input that specifies the different roles that should be compartmentalized on the device. For example, a user might operate in three roles (e.g., a parent, a volunteer, and an employee). The user can specify these three specific roles, although the user can also operate in other roles (e.g., spouse, friend, student, organizer, and so on). In accordance with some aspects, partition component 102 can compartmentalize the device based on observance of intrinsic evidence and/or extrinsic evidence. Intrinsic evidence can include how communications, games, files, and other resources are utilized on the device (e.g., saved, deleted, referenced, and so forth). Extrinsic evidence can include a telephone number, alias, Internet Protocol address, and the like, from which the communication, game, photograph, and so forth is received. Another type of extrinsic evidence can be the time the communication is received (e.g., if received during normal work hours it might be intended for a work role). As the communications and/or resources are received, they are automatically received by and/or retained by the appropriate role or virtual portion 104.

Also included is a segregation component 106 that can be configured to isolate each of the at least two virtual portions. The isolation provides that communications intended for one role cannot be accessed by a user that is authorized to view communications for a different role. For example, there are various situations in a work environment when applications or programs need to be provided in order for an employee to perform job functions. The application or program can be managed by an individual associated with an Information Technology (IT) department. The IT individual might have rights to view or access the work role on the single device but not the personal role (or other roles). Thus, segregation component 106 can be configured to selectively allow the IT individual to access and perform the necessary actions on the work role virtual portion, while not allowing access to the other virtual portions. In such a manner, the personal role (or other role) is not accessible by the IT individual, thus maintaining a level of security for the device user.

Segregation component 106 can maintain isolation among the different virtual portions 104 and facilitate changes to one portion without affecting the other portions. In such a manner, one of the virtual portions 104 can be reconfigured while the other portions retain a current configuration. In accordance with some aspects, segregation component 106 segregates the portions so minimal, if any, cross utilization of operating system functionality occurs between different portions, thus, providing further isolation of the portions. However, in accordance with some aspects, the operating system functionality is utilized across portions.

Also included in system 100 is an oscillation component 108 that can be configured to selectively alternate between the virtual portions 104. The device can alternate between portions based on a function, a communication, a resource, or combinations thereof. The function can be a request for an application (e.g., docketing application) that is associated with only one of the roles or portions (e.g., a work role). The communication can be an incoming communication, which can be defined for a particular role based on the sender and/or an outgoing communication, which can be defined for a particular role based on the intended receiver. The resources can be any resources available on the device.

In accordance with some aspects, the oscillation component 108 changes roles based on a received input and/or user request. For example, a user might be leaving work and can provide a manual input indicating that a family role is being transitioned into and, similarity, the device should transition to a personal role.

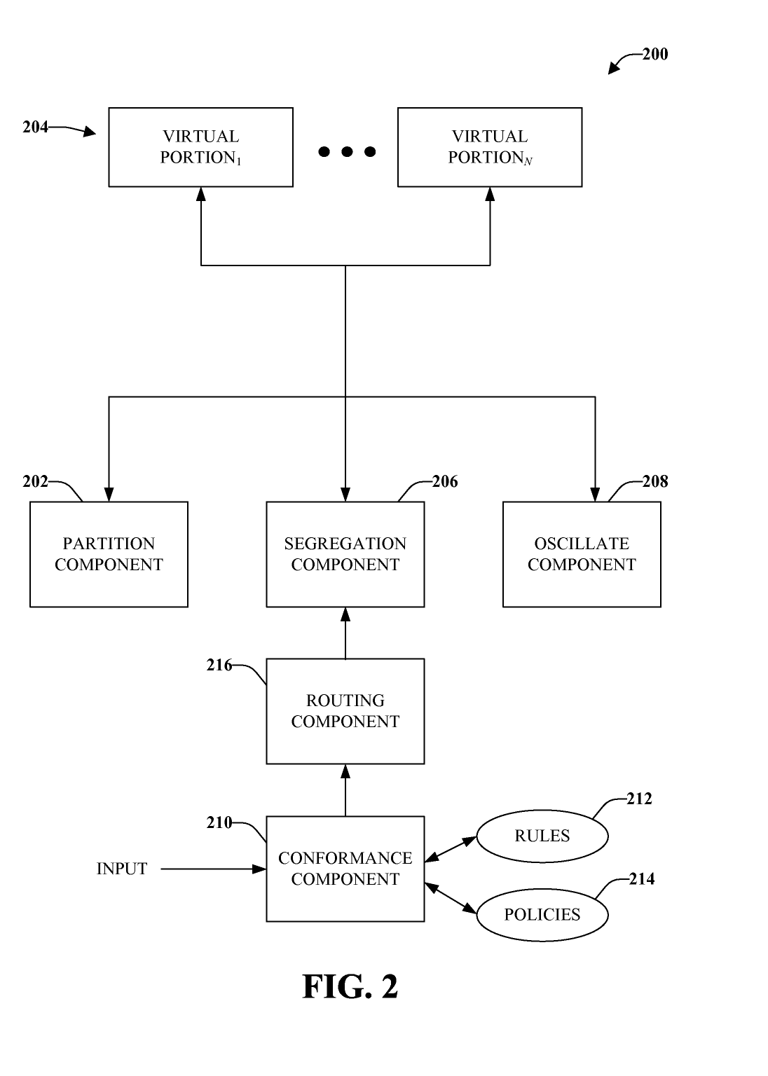

FIG. 2 illustrates a system 200 for managing a device having distinct virtual portions. At any time, a user can be in one or more roles. A single individual can be known to different people based on diverse interactions. For example, an individual can be a volunteer at a non-profit human rights organization. The other volunteers and staff members at the non-profit organization might be aware that the individual has a full-time job, a family, and attends night-classes at a local college. However, the friends at the non-profit organization might only associate the individual in her role as a volunteer at the non-profit organization. In fact, the individual might have a contact alias (e.g., email) for others to contact her at non-profit organization, depending on the type of volunteering. In some situations, the volunteer might desire to have a phone number at which the volunteer can be contacted without compromising the privacy of the individual (e.g., home number, work number); however, the individual does not desire to maintain separate communication devices. Thus, system 200 can allow the individual to be known by a contact alias as it relates to volunteering at the non-profit organization and receive communications relating to the volunteer role at a single device that also receives communications intended for the other roles engaged in by the individual (e.g., spouse, parent, student, co-worker, employee, and so on). The communications intended for the volunteer role can be segregated from the other roles, to maintain a level of confidentiality for the individual (e.g., employer cannot access personal communications).

System 200 includes a partition component 202 that sub-divides a single device into virtual portions 204 that are associated with a user role. A segregation component 206 is configured to isolate each virtual portion to maintain privacy of the communications and/or resources contained in each portion. Also included is an oscillation component 208 that selectively transitions or alternates between virtual portions 204 based on the role in which the user is currently functioning.

As an input (e.g., email, voice message, text message, transferred file, gaming application, search request, and so on) is received, a conformance component 210 can be configured to evaluate an input as a function of a rule 212 or a policy 214. The rule 212 can be associated with a sender of the communication or an intended recipient of the communication. For example, if the sender or intended recipient is a spouse, the rule can associate the spouse identification (e.g., email alias, screen name, IP address, and so on) with a personal role. In another example, a rule can associate an employer (e.g., based on a domain name) with a work role. The policy 214 can relate to applications, communications, or other resources that can be (or should not be) associated with a virtual portion 204. For example, a policy might be that a gaming application should not be associated with a virtual portion 204 that relates to a work role.

A routing component 216 can be configured to direct the input to one of the virtual portions 204 based on the evaluation. As the input is being routed to the appropriate virtual portion 204, the routing component 216 and/or segregation component 206 can maintain that input in confidence, regardless of the role in which the user is current functioning (e.g., the virtual portion 204 being utilized). In such a manner, if an authorized user (or unauthorized user) has access to the device, the input (intended for a different role) cannot be accessed by the user.

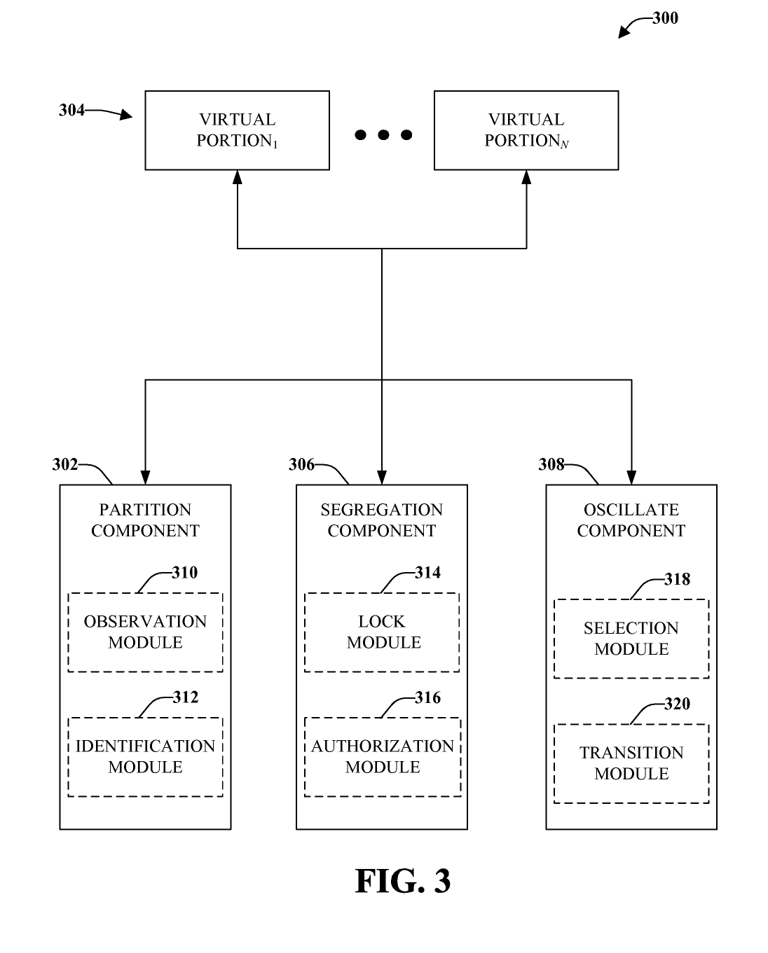

FIG. 3 illustrates a system 300 for maintaining two or more separate virtual devices within a single device. System 300 provides a hypervisor functionality that can control various portions of a single device while not controlling other portions of the device by maintaining two or more separate virtual portions (e.g., operating systems) in the single device. In such a manner, the single device functions as if it is two or more separate devices. Thus, an individual can use one device for all communications, applications, resources, functions, and so forth, regardless of whether intended for a business role, a personal role, or other roles. In addition, a virtual portion can be modified without influencing the other virtual portion. For example, the work-related classification and all applications, functions, resources etc. related to the work classification can be selectively removed, added, modified and so forth without having any impact on the personal (or other) virtual portions.

System 300 is illustrated and described with reference to various modules that provide functionality associated with the one or more disclosed aspects. However, as indicated previously, not all modules are necessary to implement the features. In addition, one or more modules can be utilized in various combinations to perform the disclosed functions.

Included in system 300 is a partition component 302 that separates a device into two or more virtual portions 304, a segregation component 306 that provides isolation between the two or more virtual portions 304, and an oscillation component 308 that facilitates transition between the virtual portions 304.

To facilitation separating the device into portions 304, partition component 302 can include an observation module 310 and/or an identification module 312. Observation module 310 can be configured to monitor a user's activities to ascertain the various roles that a user can be in at different times of the day. The roles (or personas) can relate to a work role, a family or home role, a personal role, and so on. Based on the monitored activities, observation module 310 can divide the device into separate portions 304 and/or can add or delete portions based on the monitoring. If a new user role is observed, observation module 310 can selectively create a new virtual portion. For example, is there are two virtual portions, observation module 310 can cause a third virtual portion to be created if the observed behavior indicates that a particular role is not supported by the existing two virtual portions. In accordance with some aspects, if a virtual portion is no longer utilized, based on the observed activities, observation module 310 can cause the no longer utilized virtual portion to be deleted. For example, a partition had been previously made based on a student role. However, the user has graduated and is no longer attending an educational institution. Based on the monitoring, observation module 310 can observe that the student role is no longer utilized by the user, such as over a period of time (e.g., weeks, months). A query can be presented to the user asking if the role should be removed and/or partition component 302 can automatically deactivate or remove the portion relating to the student role. Similarly, observation module 310 might determine that an additional partition should be included on the device based on a new role engaged in by the user.

Identification module 312 can be configured to categorize the various roles and corresponding each virtual portion 304 with a different user role. In accordance with some aspects, the categorization can be based on a manual identification. The user might desire that more or less partitions be created than roles in which the user might be engaged. Additionally or alternatively, identification module 312 can be configured to associate various identification information with a particular partition (or role). The identification information can include a sender and/or recipient of a communication, key words or key phrases, applications, document titles and/or properties, as well as other parameters.

Segregation component 306 can include a lock module 314 and/or an authorization module 316. Lock module 314 can be configured to restrict access to one or more virtual portions 304. The access can be restricted based on a manual configuration specified by the user. In accordance with some aspects, an authorization module 316 can be configured to restrict access based on an individual attempting to access the device (e.g., user name/password pair or other authentication means). The authorization can be made by the user to selectively allowing access to the device (e.g., employer has access to a virtual (work) portion but a spouse does not have access to that virtual (work) portion).

To selectively transition between virtual portions 304, oscillation component 308 can include a selection module 318 and/or a transition module 320. Selection module 318 can be configured to apply an input to the virtual portion associated with the user role for which the input was intended. In accordance with some aspects, selection module 318 can be configured to receive a user selection to make the transition between virtual portions 304. The user selection can be made based on a current activity of the user (e.g., the user arrives at work and desires to transition to a work role). The user selection can be made based on the user desiring to access certain information (e.g., resource, communication, and so no) associated with a role in which the user is not currently engaged.

In accordance with some aspects, the transition module 320 can be configured to selectively change from a first virtual portion to a second virtual portion based on observed activities. As such, transition module 320 can function as a filter when a user forgets or for other reasons does not indicate in which role they are functioning at a particular point in time. The observed activities can include, but are not limited to, a location of the user (e.g., based on a Global Positioning System or other locating means), a time of day (e.g., during 9 a.m. and 6 p.m. the user is in a work role and at other times, in a personal role). The activities can also include a request for various applications, files, games, documents, photographs, and so forth, that are associated with a role (e.g., partition) that is not active. Transition module 320 can interpret a request as a desire by the user to change roles or that the user has in fact changed roles.

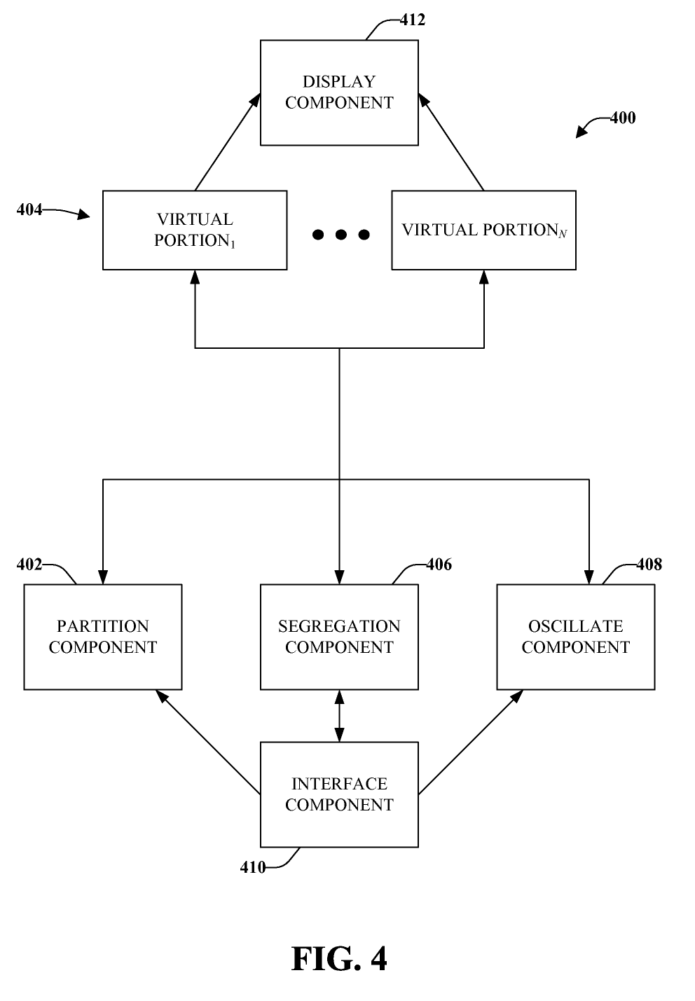

FIG. 4 illustrates a system 400 for supporting multiple roles on a device in a secure manner. The support can include how the communications, resources, etc. are separated and/or how the communications, resources, etc. can be converged on a single device. In such a manner, system 400 can allow all communications to be facilitated on a single device, mitigating the need for duplicate devices.

System 400 is similar to the above systems and includes a partition component 402 that creates two or more virtual portions 404 on the device and a segregation component 406 that securely maintains the information contained in each virtual portion 404. In addition, system 400 includes an oscillation component 408 that transitions or changes between the virtual portions 404 based on a current activity of the user.

The user can interact with system 400, through an interface component 410, to establish one or more roles, which can be utilized by partition component 402 to create the virtual portions 404. The user can specify the number of roles that the user would like to segregate among and the types of roles (e.g., family, work, friend, volunteer, club member, teammate, and so on). The user can also interact with interface component 410 to apply rules and/or polices to each virtual portion 404, as well as other preferences. In accordance with some aspects, the user can delete one or more virtual portions 404 through a selection associated with interface component 410.

Through interaction with interface component 410, the user can also establish one or more authorized individuals that can access a particular virtual portion 404. For example, the user might give an employer access to a work role (e.g., work partition) so that various maintenance and other functions can be performed as it relates to the employer. The authorized person can be identified by a user name/password pair or based on other access control and/or authentication means (e.g., biometrics, digital signature, smart card, or other credentials).

If the user desires to manually transition from one role to another (e.g., user is going home from work early and wants to utilize the device for personal reasons and does not want to be interrupted with work communications), the user can manually request oscillation component 408 to implement the transition. The manual entry from the user can be input into interface component 410.

The user interface component 410 can be of various types including, a graphical user interface (GUI), a command line interface, a speech interface, Natural Language text interface, and the like. For example, a GUI can be rendered that provides a user with a region or means to select a user role, to load, import, select, read, change information, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

As information (e.g., application, resource, communication, data, and so forth) is requested by the user and/or received by the device and intended for a current user role (e.g., the role in which the user is active), a display component 412 can render the information in a perceivable format (e.g., audio, visual). The display component 412 can also provide information relating the current role (e.g., virtual portion) in which the device is operating. The information is rendered to the user by display component 412 in a seamless manner such that the user does not need to be aware of the partition from which the information was accessed and/or that a different role or virtual portion was transitioned into by device.

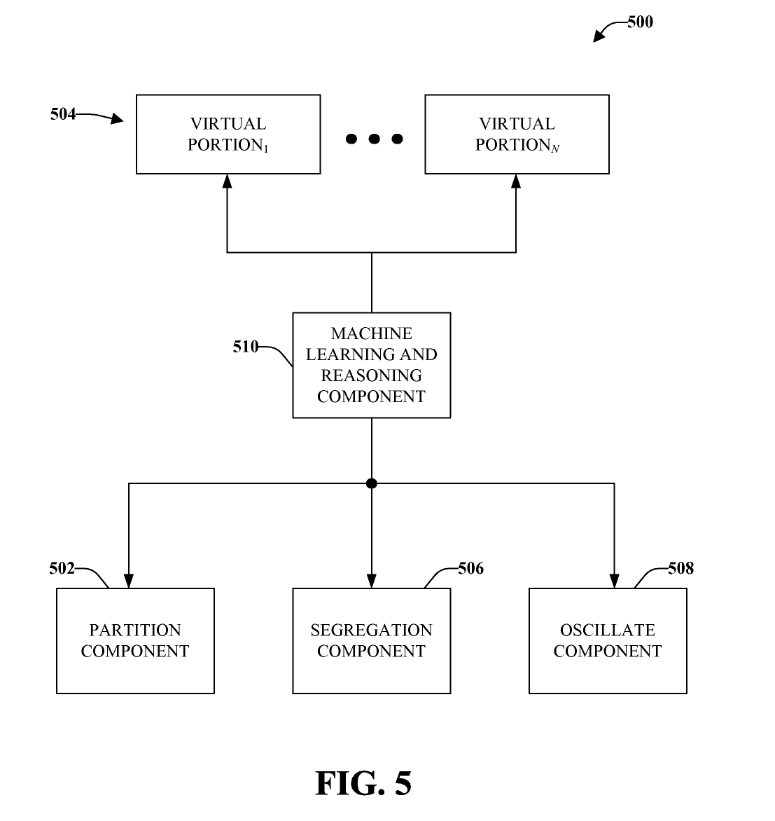

FIG. 5 illustrates a system 500 that employs machine learning and reasoning, which facilitates automating one or more features in accordance with the one or more aspects. System 500 includes a partition component 502 that can divide a device into at least two virtual portions 504. Each virtual portion can correspond to a different user role. Also included is a segregation component 506 that isolates each of the at least two virtual portions 504. An oscillation component can selectively alternate between that two or more virtual portions 504 based on various factors that include a user request, a function, a communication, a resource, or combinations thereof. Machine learning and reasoning can be facilitated by a machine learning and reasoning component 510, as illustrated.

The various aspects (e.g., in connection with partitioning a single device into two or more virtual portions, each portion associated with a unique user persona or role) can employ various machine learning and reasoning schemes for carrying out various aspects thereof. The machine learning and reasoning can be facilitated through artificial intelligence, rules based logic, or other logic.

Artificial intelligence based systems (e.g., explicitly and/or implicitly trained classifiers) can be employed in connection with performing inference and/or probabilistic determinations and/or statistical-based determinations as in accordance with one or more aspects as described herein. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, and so forth) can be employed in connection with performing automatic and/or inferred action in connection with the subject aspects.

For example, a process for determining the number and types of virtual portions that should be associated with a user and/or in which virtual portion a particular communication should be retained can be facilitated through an automatic classifier system and process. Moreover, where multiple virtual portions are employed, the classifier can be employed to determine which user (e.g., identified by a user name/password pair or though other means) has authorized access to which virtual portion in a particular situation.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of communications, for example, attributes can be words or phrases or other data-specific attributes derived from the words (e.g., importance of the communication, the presence of key terms), and the classes are categories or areas of interest (e.g., levels of priorities, sender of the communication).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVMs are configured through a learning or training phase within a classifier constructor and feature selection module. Thus, the classifier(s) can be used to automatically learn and perform a number of functions, including but not limited to determining according to a predetermined criteria when to grant access to a virtual portion, which virtual portion to access, whether a virtual portion should be added or deleted, and so forth. The criteria can include, but is not limited to, the user role, the location of a particular communication, the type of communication, the importance of the data, a user request, and so on.

In accordance with some aspects, rules rules-based logic can be utilized to control and/or regulate access to one or more virtual portions. It will be appreciated that the rules-based implementation can automatically and/or dynamically regulate access and authentication based upon a predefined criterion. In response thereto, the rule-based implementation can grant and/or deny access by employing a predefined and/or programmed rule(s) based upon any desired criteria (e.g., data type, data size, data importance, authentication information, and so forth).

By way of example, a user can establish a rule that can require a trustworthy flag and/or certificate to access a virtual portion whereas, other virtual portions may not require such security credentials. It is to be appreciated that any preference can be facilitated through pre-defined or pre-programmed in the form of a rule.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

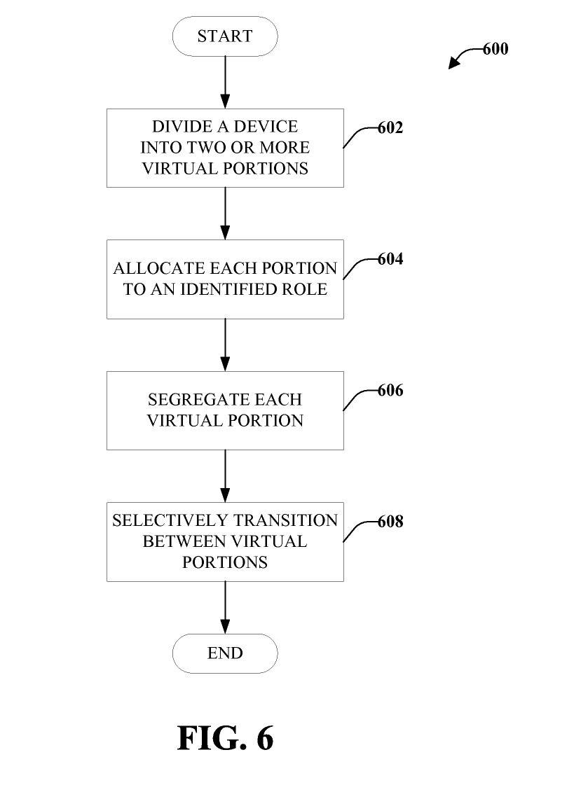

FIG. 6 illustrates a method 600 for managing a device having distinct virtual portions. A user might desire to utilize a single communication device for all communications (e.g., voice messages, text messages, SMS messages, email, and so forth), data (files, photographs, games, videos, and so on), applications, and other functions associated with a device. Method 600 can allow the user to utilize the single device for the multiple roles or personas by allocating one or more portions or subsets of device operating system functionality, each of the portions or subsets is dedicated for a particular role or persona in which the user can be engaged in at any time.

Method 600 starts, at 602, when a device is divided into two or more virtual portions. Dividing the device into the virtual portions can include dividing an operating system to allow each virtual portion to carry out desired functions with minimal, if any, support from the other virtual portions. The number of virtual portions can be determined based on the number of roles in which the user could be in at any time. In accordance with some aspects, the user can specify the types of roles (and number) that are desired based on how the device is to be utilized. For example, the user might specify that the roles are a work role, a family role, and a student role. In such a manner, the user might be performing functions for work (e.g., creating an executive summary, communicating with a client), for school (e.g., drafting a thesis, performing research), or for their family (e.g., modifying a recipe, paying personal bills).

At 604, each virtual portion is allocated for a different user role. The allocation includes assigning a first virtual portion to a first user role so that all communications and/or data intended for the first user role are automatically associated with the first virtual portion. Subsequent user roles can be assigned to the subsequent virtual portions. In this manner, communications and/or data intended for a one role are not accidentally directed to or stored within a subset intended for a different role, thus maintaining confidentially.

Each virtual portion is segregated from the other virtual portions, at 606. The segregation provides that an authorized user that has access to one virtual portion cannot access a different virtual portion maintained on the device. The segregation also allows changes to be made to a first virtual portion without affecting a second (or more) virtual portion. Thus, if one portion is reformatted or the applications contained therein deleted (or added), the other portions are not reformatted and/or applications are not deleted/added. The segregation can be made based on a manual request, observed behavior, or combinations thereof. For example, if a particular portion is utilized for a work role, an application might need to be removed (e.g., if the worker has resigned from the company). In this case, a representative of the employer can access the device and remove the application without affecting the other portions (which might be a personal role that utilizes a similar application).

At 608, selective transition between the virtual portions occurs. The transition can be based on a manual request to change roles (e.g., arriving at work, ready to study for college). The transition can be made based on observed activity or behavior of the user (e.g., searching by file name, keywords, key phrases, author, and so on) and determining that the user has changed roles based on the observed behavior. For example, the user is searching for a file authored by their subordinate. However, the user is not aware that a current role with which the user is associated (either automatically or through a manual selection) is a family role. Thus, the activity (e.g., search) is observed and it is automatically determined that the user should be associated with the work role, not the family role. Thus, at 608, a transition is automatically made between the roles. In accordance with some aspects, the transition is made based on a manual request to change the roles (e.g., leaving work for the day and the user desires to transition into a personal role). Thus, the manual input can specify the change.

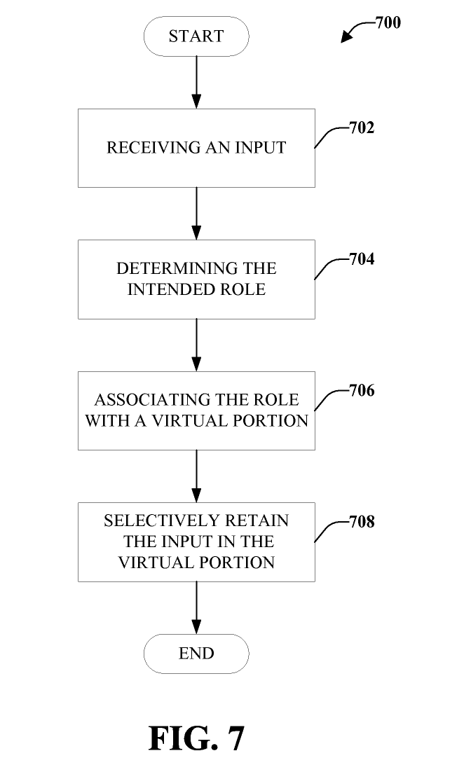

FIG. 7 illustrates a method 700 for selectively partitioning a device based on a user role and routing inputs to the designated portion. Method 700 starts, at 702, when an input is received. The input can be intended for one of the different user roles. The input can be from an external source (e.g., a sender of a communication), another device, an application, the Internet, and so forth. The input can also be received from the user of the device, such as though interaction with a keyboard, mouse, pointer, or other interface device.

At 704, a determination is made as to the role for which the input is intended. The determination can be made based on information associated with the sender of the input, keywords or key phrases included in the input, type of input, or other parameters associated with the input. In accordance with some aspects, the determination can be made based on rules and/or policies that are predefined or inferred based on observed actions, historical information, and other data. In accordance with some aspects, the determination can be made based on a selection by the user. For example, the user can select an application to be downloaded on the device and, at substantially the same time specify the role for which the application applies.

Based on the determination, at 706, the intended role is associated with a virtual portion. In accordance with some aspects, a virtual portion can be associated with similar roles. For example, a family portion can include inputs intended for a spouse role, a parent role, a child role, and the like. Each of these roles, being similar, can relate to the same family portion while still maintaining the security or confidentiality associated with the roles (e.g., an employer does not have access to a personal partition, a friend does not have access to a work partition).

At 708, the input is selectively retained in the virtual portion identified, at 706. The input can be retained in manner that supports confidentiality of the input while it is being retained, regardless of the role in which the device (and associated user) is actively engaged. In such a manner, if an authorized (or unauthorized) person has access to the device, the input (intended for a portion not accessed by the person) is unavailable.

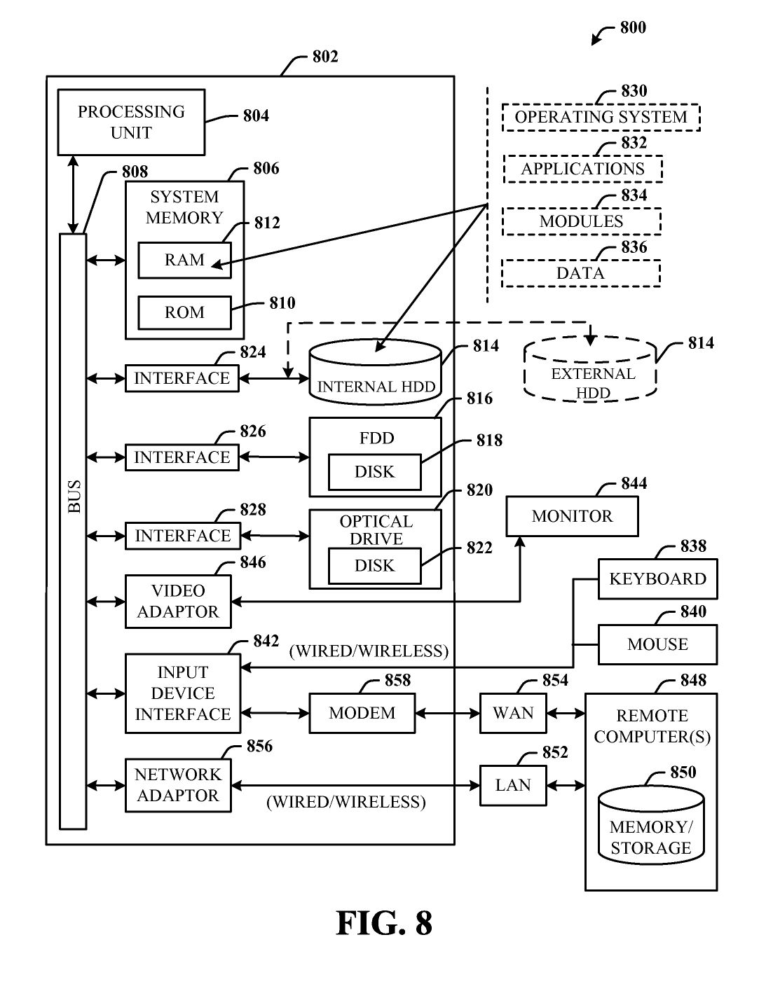

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various aspects can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 through an interface, such as a video adapter 846. In addition to the monitor 844, a computer typically includes other peripheral output devices (not shown), such as speakers, printers, etc.

The computer 802 may operate in a networked environment using logical connections through wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 through the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

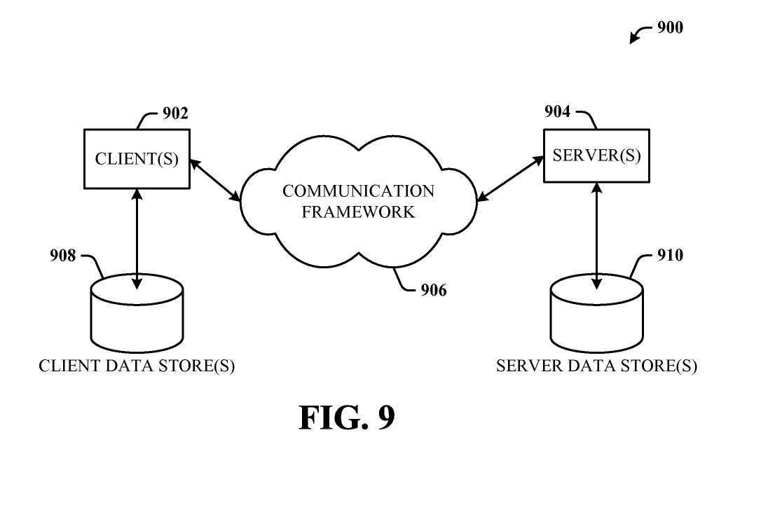

Referring now to FIG. 9, there is illustrated a schematic block diagram of an exemplary computing environment 900 in accordance with the various aspects. The system 900 includes one or more client(s) 902. The client(s) 902 can be hardware and/or software (e.g., threads, processes, computing devices). The client(s) 902 can house cookie(s) and/or associated contextual information by employing the various aspects, for example.

The system 900 also includes one or more server(s) 904. The server(s) 904 can also be hardware and/or software (e.g., threads, processes, computing devices). The servers 904 can house threads to perform transformations by employing the various aspects, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated through a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ) smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system for administrating virtual classifications on a single device, comprising:
a partition component that divides a device into at least two virtual portions, each virtual portion corresponds to a different user role;
a segregation component that isolates each of the at least two virtual portions; and
an oscillation component that selectively alternates between the at least two virtual portions.

2. The system of claim 1, the segregation component facilitates changes to one of the at least two virtual portions without affecting the other portion.

3. The system of claim 1, the oscillation component alternates between the at least two virtual portions based in part on a function, communication, resource, or combinations thereof.

4. The system of claim 1, the oscillation component alternates between the at least two virtual portions based on a user request.

5. The system of claim 1, further comprising:
a conformance component that evaluates an input as a function of a rule or a policy; and
a routing component that directs the input to one of the at least two virtual portions based on the evaluation.

6. The system of claim 1, further comprising a lock module that can be configured to restrict access to one of the at least two virtual portions based on a manual input.

7. The system of claim 1, further comprising an observation module that monitors activities of a user to ascertain the different user roles.

8. The system of claim 1, further comprising a transition module that observes activities and notifies the oscillation component to implement a change between the at least two virtual portions.

9. The system of claim 1, further comprising an observation module that monitors activities of a user and deletes a virtual portion that is no longer utilized.

10. The system of claim 1, the partition component adds at least third virtual portion based on observing behavior relating to a role not associated with the at least two virtual portions.

11. The system of claim 1, further comprises a machine learning and reasoning component that automates one or more functions of system.

12. A method, comprising:
dividing a device into a first virtual portion and at least a second virtual portion;
allocating each portion to a different user role;
segregating the first virtual portion from the at least a second virtual portion; and
selectively transitioning between the first virtual portion and the at least a second virtual portion.

13. The method of claim 12, further comprising:
receiving an input intended for one of the different user roles;
determining an intended role;
associating the intended role with an associated virtual portion; and
retaining the input in the associated virtual portion.

14. The method of claim 13, determining the intended role is based on parameters associated with the input.

15. The method of claim 13, determining the intended role is based on a rule or policy.

16. The method of claim 12, selectively transitioning between the first virtual portion and the at least a second virtual portion comprises receiving a manual input that specifies the change.

17. The method of claim 12, selectively transitioning between the first virtual portion and the at least a second virtual portion comprises:
observing a user behavior; and
determining that the user has changed roles based on the observed behavior.

18. The method of claim 12, segmenting the device into a first virtual portion an at least a second virtual portion is based on a manual request, on observed behavior, or combinations thereof.

19. A computer-readable medium having stored thereon the following computer executable components:
means for dividing a single device into a plurality of virtual portions;
means for associating each of the plurality of virtual portions with a different user role;
means for accepting an input intended for at least one of the different user roles;
means for applying the accepted input to the virtual portion associated with the intended user role; and
means for selectively rendering the accepted input.

20. The computer-readable medium of claim 19, further comprising:
means for monitoring a user activity; and
means for changing from an active virtual portion to one of the plurality of virtual portions.
